(19) United States
(12) Patent Application Publication
(10) Pub. No.: US 2026/0131494 A1
(43) Pub. Date: May 14, 2026

(54) MINERAL WOOL CUTTING TOOL

(71) Applicant: AMES TOOLS CORPORATION, Suwanee, GA (US)

(72) Inventors: Matthew W. Jungklaus, Lawrenceville, GA (US); Michael T. Ventura, Palm Beach Gardens, FL (US)

(21) Appl. No.: 19/353,382

(22) Filed: Oct. 8, 2025

Related U.S. Application Data
(60) Provisional application No. 63/705,718, filed on Oct. 10, 2024.

(51) Int. Cl. B26D 3/06; B26D 7/18; B26D 7/26

(52) U.S. Cl. CPC B26D 3/065; B26D 7/1836; B26D 7/2614

(57) ABSTRACT

A mineral wool cutting tool, configured to create a channel within a surface of a sheet of mineral wool, includes a sled configured to rest on and move along the surface of the mineral wool, a blade extending below the sled and having a closed profile and a sharpened edge configured to cut a plug from the mineral wool, and a handle extending above the sled and graspable by a user for moving the sled along the mineral wool.

### CROSS-REFERENCE TO RELATED APPLICATIONS

This application claims priority to U.S. Provisional Patent Application No. 63/705,718, filed Oct. 10, 2024, the entire contents of which are herein incorporated by reference.

### FIELD OF THE INVENTION

The present invention relates to mineral wool cutting tools and, more particularly, to such tools for cutting a channel into a surface of mineral wool, for example, to create a design element in the mineral wool.

### BACKGROUND OF THE INVENTION

Mineral wool, also known as stone wool, is used in a wide range of applications based on thermal, acoustic, and fire-resistant properties. Mineral wool is used as insulation within walls of a building to assist in maintaining an internal temperature of the rooms within the building and to further provide soundproofing and fire resistance. Some mineral wool materials are usable as an external material (i.e., not within a wall) where the mineral wool is visible. Mineral wool materials are limited in their use as external design materials based on a difficulty of forming design elements within the material. The techniques described herein cure this deficiency of the prior art.

Serrated knives are typically used to cut mineral wool batts to length (i.e., cutting fully through the batt); however, these serrated knives are not useful in cutting a decorative design into a mineral wool material. In a related field, hot foam cutters use a heated wire or blade (e.g., nickel chromium) to cut through foam materials, though these do not work to cut through mineral wool, which is significantly denser than most foam materials, includes many individual fibers that need to be severed, and is significantly more heat resistant.

### SUMMARY OF THE INVENTION

In some aspects, the techniques described herein relate to a mineral wool cutting tool configured to create a channel within a surface of a sheet of mineral wool, the mineral wool cutting tool including: a sled configured to rest on and move along the surface of the mineral wool; a blade extending below the sled and having a closed profile and a sharpened edge configured to cut a plug from the mineral wool; and a handle extending above the sled and graspable by a user for moving the sled along the mineral wool.

In some aspects, the techniques described herein relate to a mineral wool cutting tool, further including a separator configured to separate the plug from a remainder of the mineral wool after being cut by the blade.

In some aspects, the techniques described herein relate to a mineral wool cutting tool, wherein the separator is integrally formed with the blade as a single piece.

In some aspects, the techniques described herein relate to a mineral wool cutting tool, wherein the separator is a wheel rotatably coupled to the sled and configured to grab the plug for rotation with the wheel.

In some aspects, the techniques described herein relate to a mineral wool cutting tool, further including a mounting assembly configured to releasably secure the blade to the sled.

In some aspects, the techniques described herein relate to a mineral wool cutting tool, wherein the mounting assembly includes a base coupled to the sled and a cap movably coupled to the base, and wherein the cap is configured to tighten against the base to sandwich the blade therebetween to secure the blade to the sled.

In some aspects, the techniques described herein relate to a mineral wool cutting tool, further including a set screw configured to rotate relative to the base to tighten the cap relative to the base.

In some aspects, the techniques described herein relate to a mineral wool cutting tool, wherein the base includes a pair of slots configured to simultaneously receive the blade.

In some aspects, the techniques described herein relate to a mineral wool cutting tool, wherein the pair of slots is a first pair of slots and the blade is a first blade, and wherein the base further includes a second pair of slots spaced apart from the first pair of slots and configured to simultaneously receive a second blade.

In some aspects, the techniques described herein relate to a mineral wool cutting tool, wherein the base is integrally formed as a single piece with the sled.

In some aspects, the techniques described herein relate to a mineral wool cutting tool, wherein the blade is a first blade, wherein the mineral wool cutting tool further includes a second blade having a different profile than the first blade, and wherein the first and second blades are interchangeable such that the mineral wool cutting tool is configured to create a first channel having the closed profile of the first blade and a second channel having the different profile of the second blade.

In some aspects, the techniques described herein relate to a mineral wool cutting tool, wherein the blade is configured to cut the plug from the mineral wool when the sled is moved in a forward direction, wherein the handle is a first handle, wherein the mineral wool cutting tool further includes a second handle, and wherein the first handle is positioned rearward of the blade and the second handle is positioned forward of the blade.

In some aspects, the techniques described herein relate to a mineral wool cutting tool, wherein the first handle is taller than the second handle, extending upward and rearward from the sled with a top end forming a cap that prevents a hand of the user from sliding off the first handle, and wherein the second handle is spherical for a second hand of the user to grasp.

In some aspects, the techniques described herein relate to a mineral wool cutting tool, wherein the closed profile of the blade is formed by the blade at a lower end of the closed profile and by a mounting assembly at an upper end of the closed profile, and wherein the mounting assembly is positioned above the sled.

In some aspects, the techniques described herein relate to a mineral wool cutting tool, further including a guide provided at a front end of the sled, wherein the guide is aligned with a center of the blade in a forward direction of travel of the sled.

In some aspects, the techniques described herein relate to a method 1, the method including: moving the sled along the surface of the mineral wool; concurrently with movement of the sled, cutting the plug from the mineral wool with the blade having the closed profile and the sharpened edge; and separating the plug from a remainder of the mineral wool.

In some aspects, the techniques described herein relate to a method, wherein moving the sled includes grasping a handle extending above the sled and pushing or pulling the sled along the mineral wool.

In some aspects, the techniques described herein relate to a method, wherein separating the plug from the remainder of the mineral wool includes pulling the plug upwards through the sled.

In some aspects, the techniques described herein relate to a blade for use with a mineral wool cutting tool configured to create a channel within a surface of a sheet of mineral wool, the mineral wool cutting tool including a sled configured to rest on and move along the surface of the mineral wool and a mounting assembly, the blade including: a metal body extending along a length between a first distal end and a second distal end, the metal body having a sharpened edge extending between the first distal end and the second distal end, wherein the first distal end and the second distal end are configured to be grasped by the mounting assembly to mount the blade to the mineral wool cutting tool, such that a profile formed by the blade is configured to be closed by the mounting assembly.

In some aspects, the techniques described herein relate to a blade, wherein the first distal end extends horizontally and the second distal end extends horizontally.

In some aspects, the techniques described herein relate to a blade, wherein the first distal end is coplanar with the second distal end.

In some aspects, the techniques described herein relate to a blade, wherein the length of the metal body includes at least one bend at a location spaced apart from the first distal end and the second distal end.

In some aspects, the techniques described herein relate to a blade, wherein the metal body has symmetry about a central axis such that a first side of the metal body is mirrored relative to a second side of the metal body about the central axis.

In some aspects, the techniques described herein relate to a blade, wherein the first distal end is on the first side of the metal body and the second distal end is on the second side of the metal body.

In some aspects, the techniques described herein relate to a blade, wherein the sharpened edge is formed on a forward edge of the metal body, and wherein a depth of the blade is measured between the forward edge and a rearward edge.

In some aspects, the techniques described herein relate to a blade, wherein the rearward edge is an unsharpened edge.

In some aspects, the techniques described herein relate to a blade, wherein the metal body is generally U-shaped.

In some aspects, the techniques described herein relate to a blade, wherein the metal body is hardened at the sharpened edge such that the sharpened edge has a greater hardness at the sharpened edge than a remainder of the metal body.

In some aspects, the techniques described herein relate to a blade, wherein a forward edge of the metal body is the sharpened edge and wherein a rearward edge, opposite the forward edge is a second sharpened edge.

In some aspects, the techniques described herein relate to a blade, further including a separator formed integrally with the metal body and extending upward and rearward from a trailing edge of the metal body to facilitate separation of a plug from a remainder of the sheet of mineral wool when creating the channel.

In some aspects, the techniques described herein relate to a cutting tool configured to create a channel along a surface of a material, the cutting tool including: a sled configured to rest on and move along the surface of the material; a blade extending below the sled and having a closed profile and a sharpened edge configured to cut a plug from the material; and a separator coupled to the sled and configured to move the plug away from the material.

Other aspects of the invention will become apparent by consideration of the detailed description and accompanying drawings.

### BRIEF DESCRIPTION OF THE DRAWINGS

FIG. 1 is a top perspective view of a mineral wool cutting tool.

FIG. 2 is a bottom perspective view of the mineral wool cutting tool of FIG. 1.

FIG. 3 is a perspective view of a cutting assembly of the mineral wool cutting tool of FIG. 1.

FIG. 4A is an exploded view of the cutting assembly of FIG. 3.

FIG. 4B is a perspective view of an underside of a cap of cutting assembly of FIG. 4A.

FIG. 5A is a perspective view of a blade for the cutting assembly of FIG. 3, according to one embodiment.

FIG. 5B is a perspective view of a blade for the cutting assembly of FIG. 3, according to another embodiment.

FIG. 5C is a perspective view of a blade for the cutting assembly of FIG. 3, according to yet another embodiment.

FIG. 5D is a perspective view of a blade for the cutting assembly of FIG. 3, according to yet another embodiment.

FIG. 6 is a perspective view of a blade for a cutting assembly, according to another embodiment.

FIG. 7 is a side view of the blade of FIG. 6.

FIG. 8 is a perspective view of another embodiment of a mineral wool cutting tool.

FIG. 9 is further perspective view of the mineral wool cutting tool of FIG. 8.

FIG. 10 is a cross-sectional view of the mineral wool cutting tool of FIG. 8.

FIG. 11A is a perspective view of a separator of the mineral wool cutting tool of FIG. 8.

FIG. 11B is an enlarged view of the separator of FIG. 11A.

FIG. 12 is a perspective view of the mineral wool cutting tool of FIG. 8, removing a plug from a mineral wool batt.

FIG. 13 is a further perspective view of the mineral wool cutting tool of FIG. 8, removing the plug from the mineral wool batt.

FIG. 14 is a further perspective view of the mineral wool cutting tool of FIG. 8, removing the plug from the mineral wool batt.

FIG. 15 is a perspective view of the mineral wool batt once the plug is cut and removed by the mineral wool cutting tools of FIGS. 1 and 8.

FIG. 16 is a perspective view of a roller for use with the mineral wool of FIG. 15.

FIG. 17 is a perspective view of an underside of the mineral wool cutting tool of FIG. 8.

FIG. 18 is a further perspective view of an underside of the mineral wool cutting tool of FIG. 8.

FIG. 19 is a top perspective view of another embodiment of a mineral wool cutting tool.

FIG. 20 is a bottom perspective view of the mineral wool cutting tool of FIG. 15.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

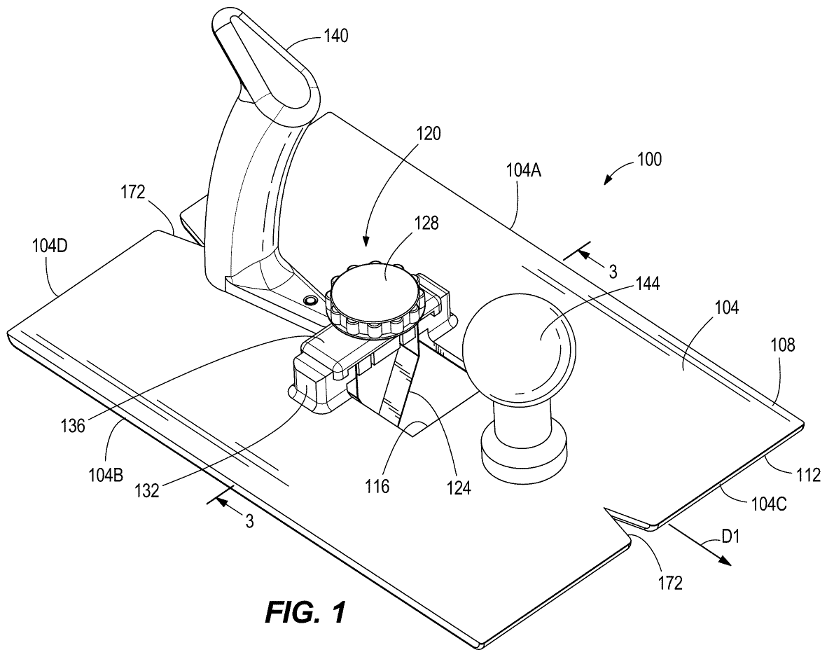

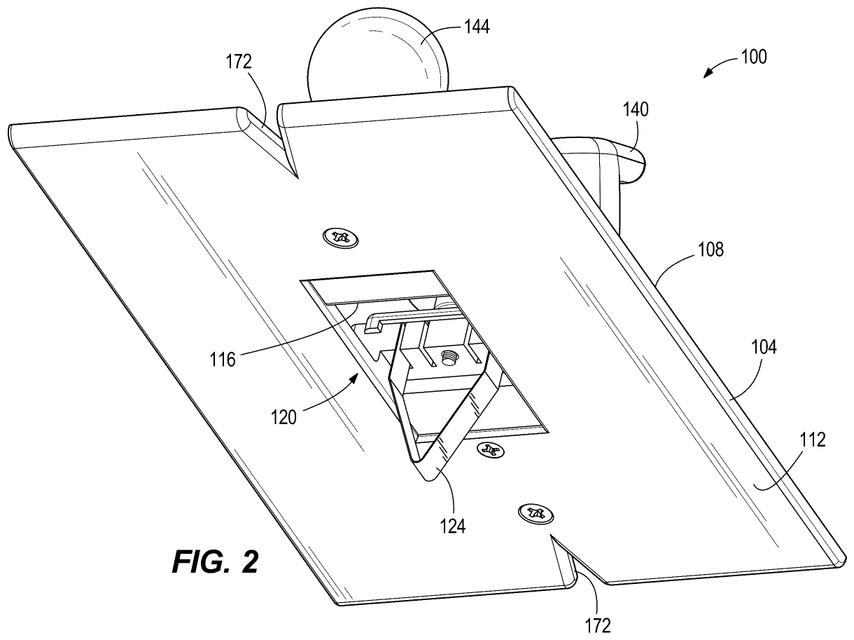

FIGS. 1-2 illustrate a mineral wool cutting tool 100 for cutting a channel into a batt or sheet of mineral wool 10 (FIGS. 8-14). The mineral wool cutting tool 100 includes a sled 104 for sliding along the mineral wool 10 and a cutting assembly 120 for cutting a channel into the mineral wool 10.

The sled 104 is generally planar and includes an upper surface 108 and a lower surface 112 parallel to the upper surface 108 and separated from the upper surface 108 by a thickness of the sled 104. Each of the upper and lower surfaces 108, 112 extends in a widthwise direction between a first side edge 104A and a second side edge 104B, and in a longitudinal direction between a forward edge 104C and a rearward edge 104D. The lower surface 112 rides along the mineral wool 10 during a cutting process. The lower surface 112 is planar to slide along a correspondingly planar surface of the mineral wool 10.

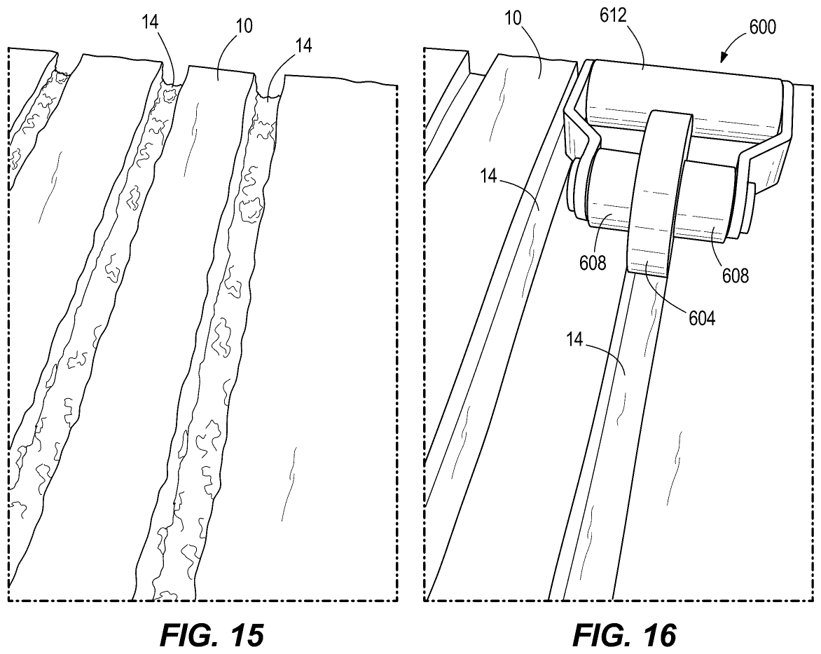

The sled 104 is movable (e.g., slidable) along the mineral wool 10 by a user pulling or pushing the sled 104 along the mineral wool 10. In normal operation, the sled 104 is moved in the longitudinal direction D1, with the forward edge of the sled 104 functioning as a leading edge. A first handle 140 and a second handle 144 extend upward from the upper surface 108 of the sled 104 and provide two handholds for a user to grasp onto and move the sled 104. The handles 140, 144 are arranged as forward and rearward handles. In the illustrated embodiment, the rearward handle 140 is taller, extending from the sled 104, upward and rearward with the top end forming a cap that prevents a hand of a user from sliding up and off the handle 140. The forward handle 144 is shorter and substantially spherical, for a second hand of a user to rest on and grasp. In other embodiments, as shown in FIG. 15, the two handles 740, 744 may be located side-by-side such that they correspond to a first side handle 740 and a second side handle 744.

An opening 116 is formed in the sled 104 and provides a passage through which a cutting assembly 120 extends from above the top surface 108 to below the bottom surface 112. The opening 116 is generally rectangular, though may be otherwise shaped or sized to provide space for a blade 124 of the cutting assembly 120 to pass through the sled 104. The opening 116 is located between the two handles 140, 144 (i.e., in the direction of travel D1 during normal operation) in the embodiment shown.

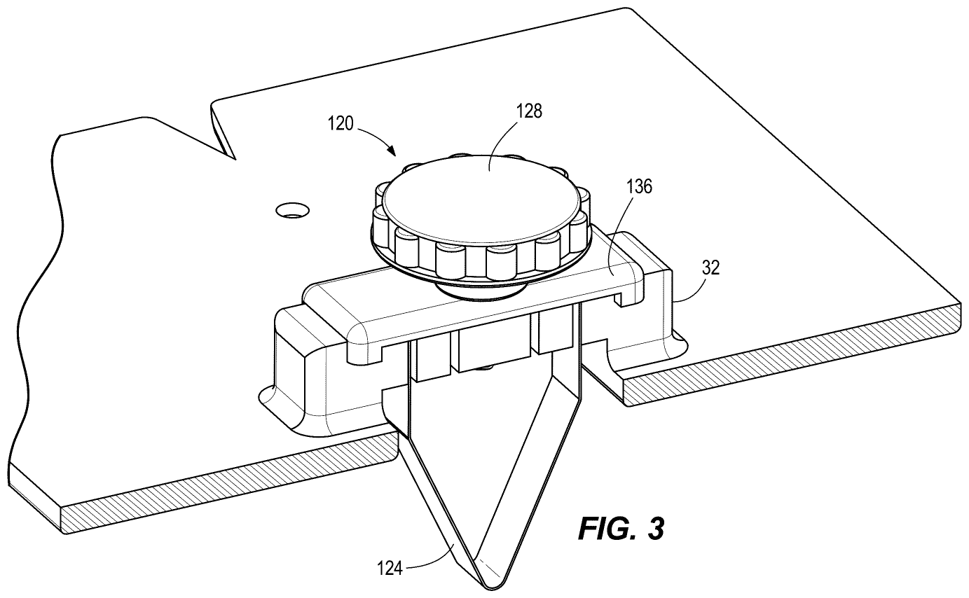

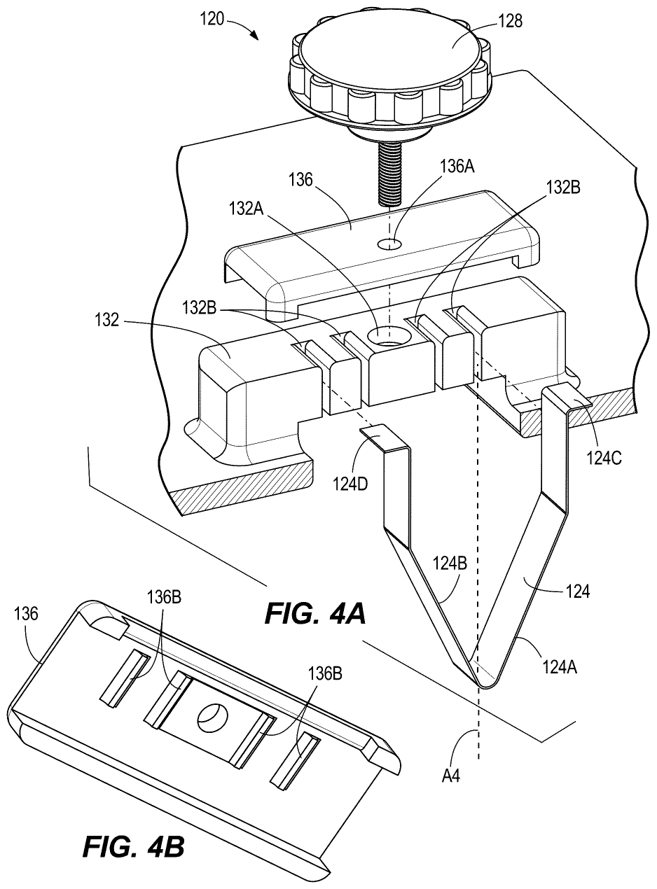

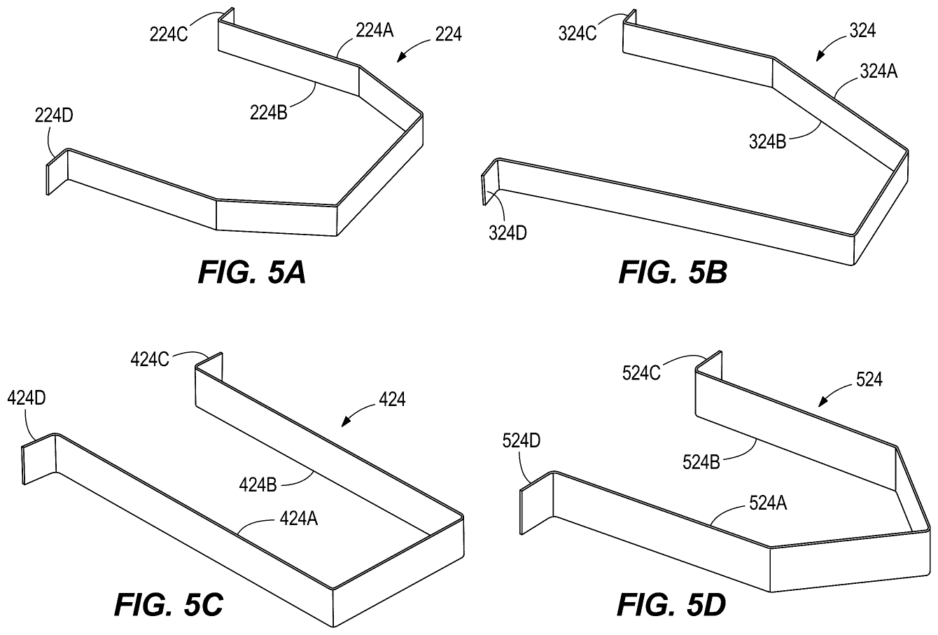

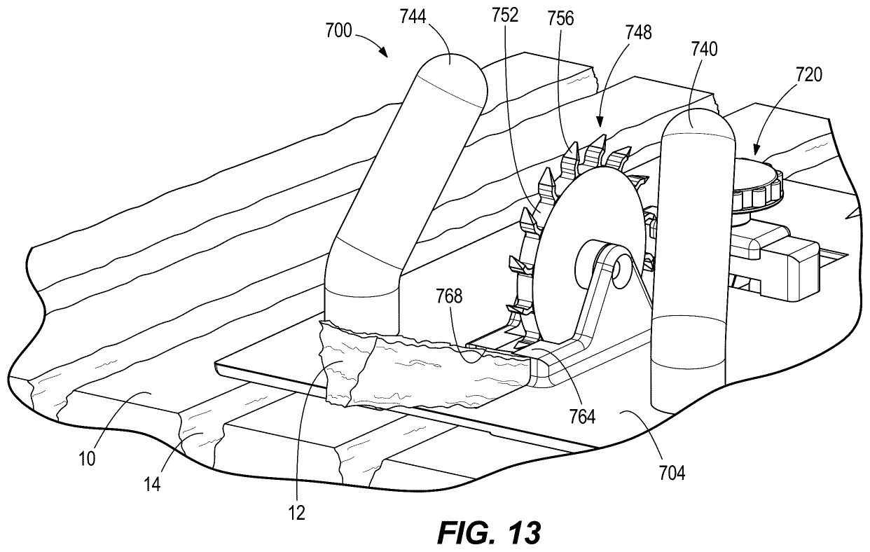

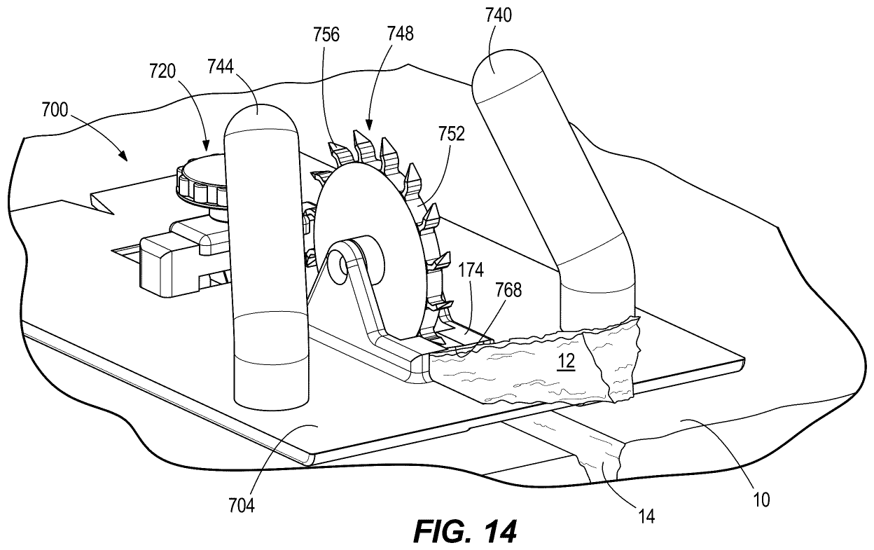

As shown in greater detail in FIGS. 3-5D, the cutting assembly 120 includes a blade 124 and a mounting assembly that includes a base 132, a cap 136, and a set screw 128. The blade 124 is a thin metal body having a sharpened edge and a profile shaped to match a desired profile of a channel 14 within the mineral wool 10. The profile of the blade 124 is a closed profile, extending downward from the sled 104 and back upwards to the sled 104 such that the area within the closed profile of the blade 124 is separated from the area outside the blade 124. In this way, a plug 12 (FIGS. 13-14) that is cut by the blade 124 is separated from the surrounding mineral wool 10. As shown, a lower portion of the closed profile is formed by the blade 124 itself, and an upper portion of the closed profile (a portion above the sled 104 such that it cannot correspond to an area in which mineral wool is to be cut) is formed by the base 132 of the mounting assembly. As shown in FIGS. 4A-5B, the profile of the blade is generally U-shaped with deviations (e.g., at vertices, at points where the blade deviates from the curve of a simple U-shape) to match the desired profile. The blade 124 is formed of a hardenable steel, with a relatively soft body, to permit bending, with only a thin portion of the cutting edge being hardened (i.e., giving it a greater hardness than the remainder of the metal body of the blade 124). As the hardened cutting edge is thin, the edge bends without fracturing, while maintaining its sharpness. The blade 124 has a thickness between a forward edge 124A and a rearward edge 124B. In some embodiments, both the forward and rearward edges 124A, 124B are sharpened so that the sled 104 can be operated in either direction and/or the blade 124 can be reversed. Opposing distal ends 124C, 124D of the blade 124 are bent relative to the remainder of the blade 124 and are sandwiched between the base 132 and the cap 136 to hold the blade 124 to the sled 104. In some embodiments, such as the embodiments shown in FIG. 4A (and FIGS. 3, 5A, 5C, and 5D), the blade 124 has symmetry about a central axis A4, where a first side of the blade 124 includes the distal end 132C oriented horizontal, extending then vertically downward, then downward and inward. A second side (having the second distal end 132D) of the blade mirrors the first side. In other embodiments, such as is shown in FIG. 5B, the blade 324 may be non-symmetrical, having the two sides differ from one another to form a non-symmetrical cutting profile. The blade 124 is a metal body extending along a length between the first distal end 124C and the second distal end 124D. The metal body has a sharpened edge extending between the distal ends 124C, 124D such that the profile formed by the blade 124 is configured to be closed by the mounting assembly (i.e., the two ends of the U-shape of the blade 124 are joined to one another to close off the profile of the blade 124 to cut a plug). In the illustrated embodiment, the sharpened edge is formed on a forward edge of the metal body of the blade 124, and a depth of the blade is measured between the forward edge and a rearward edge. The rearward edge of the illustrated embodiment is unsharpened.

In the illustrated embodiment, each of the two distal ends 124C, 124D extends horizontally (i.e., parallel to the flat surface of the material 10 upon which the sled 104 rests) and coplanar with one another. In each embodiment, the length of the metal body includes at least one bend at a location spaced apart from the first and second distal ends 124C, 124D to create the closed profile.

In order to cut various shapes of designs into the mineral wool 10, multiple different blade designs may be needed. Each blade 124 is sharpened and bent into shape, though most materials are unsuitable for this forming operation as a sharp blade will typically snap if bent into such a shape. To overcome this hurdle, only the tip (e.g., the forward cutting edge) of the blade 124 is hardened.

FIGS. 5A-5D illustrate further blades 224, 324, 424, 524 having different profiles from the one shown in FIGS. 1-5, with like reference numerals incremented by 100, 200, 300, and 400, respectively, relative to blade 124. The blade 124 shown in FIGS. 1-4B extends downward from the opposite ends 124C, 124D then narrows inward to a minimum width forming a rounded point. The blade 224 includes parallel upper edges and inwardly tapering lower edges. The blade 324 is asymmetrical, with a first side extending vertically from the top end 324D to the lower end and the second side having a parallel upper edge and inwardly tapering lower edge. The blade 424 includes parallel edges extending from the opposite ends 424C, 424D to the lower edge. The blade 524 is similar to the blade 224, though the tapered lower edges taper to a point rather than a flat lower edge.

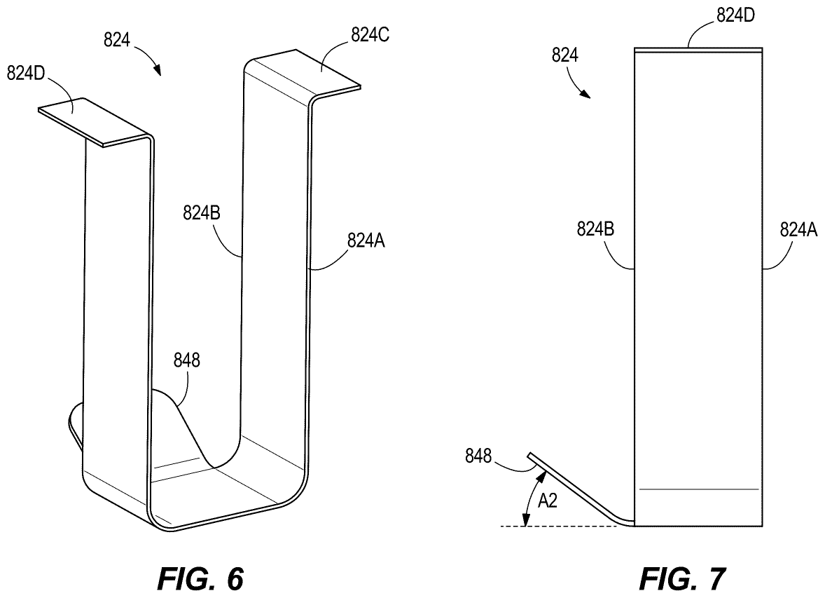

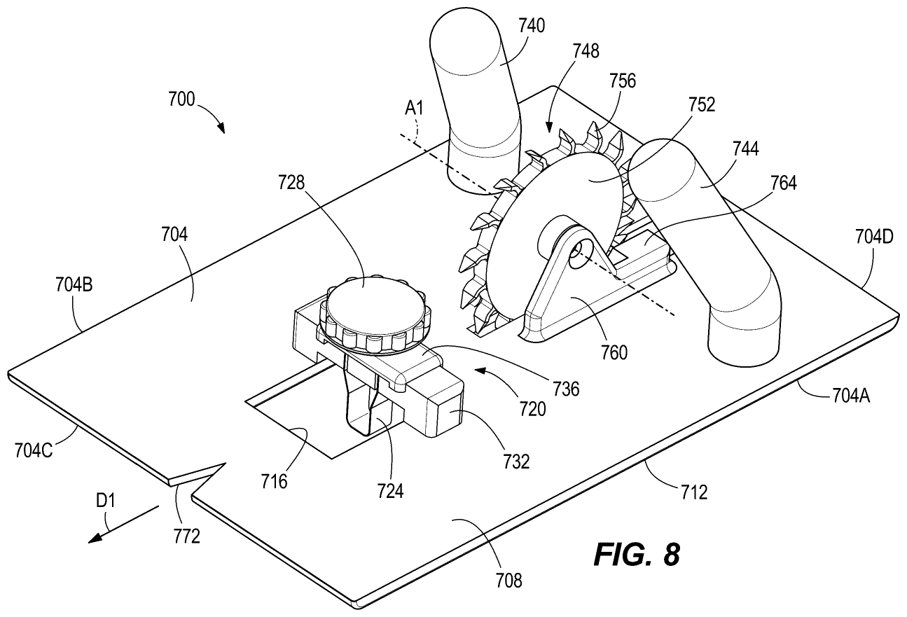

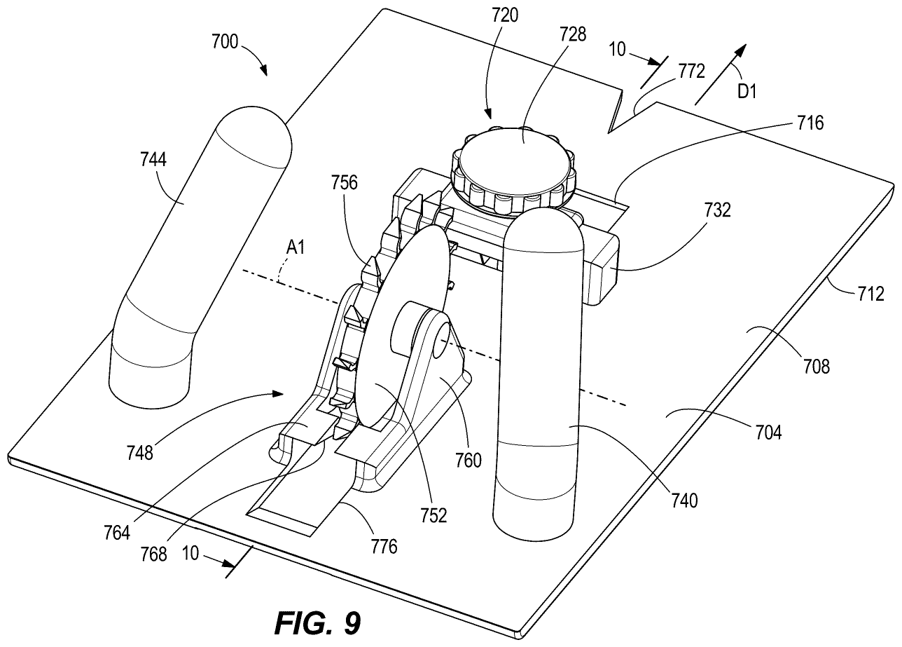

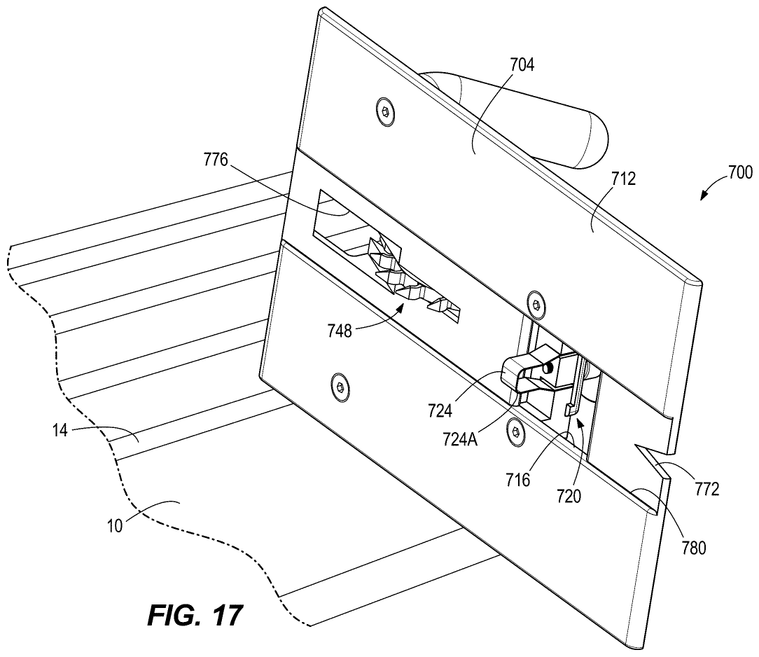

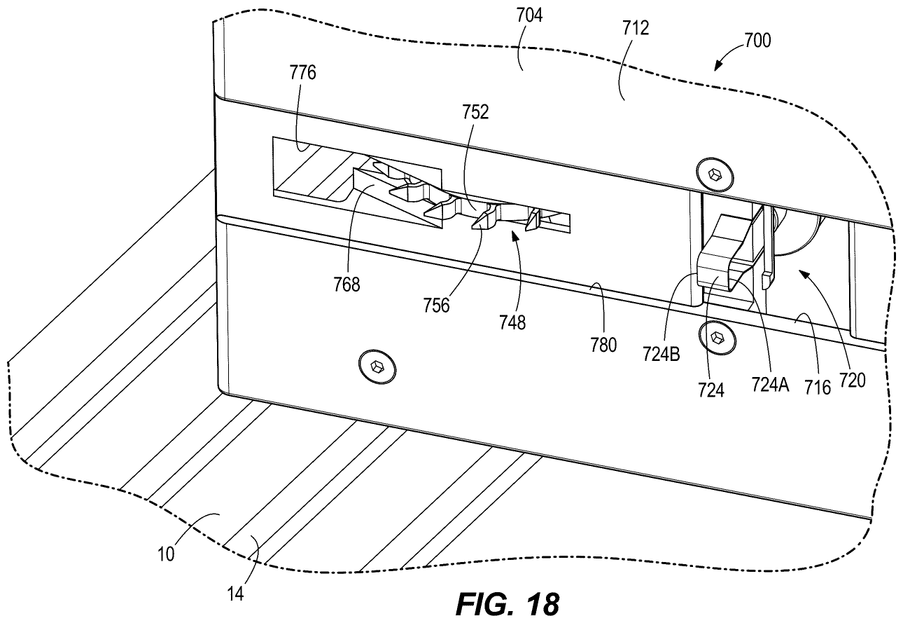

A further blade is shown in FIGS. 8 and 17-20 that narrows down from a greater width at the opposite ends 724C, 724D by inwardly extending diagonal portions to vertical portions that terminate at a flat, horizontal base. A still further blade 824 is shown in FIGS. 6-7 and extends vertically downward from the opposite ends 824C, 824D to a flat, opposite lower end. The different blades disclosed herein, as well as blades of other designs, are interchangeable with one another to create channels having different profiles.

With reference to FIGS. 4A-4B, the mounting assembly releasably secures and holds the blade 124 to the sled 104. The base 132 is coupled (e.g., fastened via threaded fasteners to, formed integrally as a single piece with) to the sled 104 and extends across the opening 116. The cap 136 rests atop the base 132 and, in some embodiments, extends around opposite edges (e.g., forward edge and rearward edge) of the base 132 to align the cap 136 on the base 132.

Aligned threaded openings 132A, 136A extend through the base 132 and cap 136, respectively. Additionally, parallel slots 132B extend vertically through the base 132 at a location below the cap 136 (when the threaded openings 132A, 136A are aligned). The slots 132B surround the threaded opening 132A. The slots 132B simultaneously receive the opposite ends 124C, 124D of the blade 124 such that the opposite ends 124C, 124D of the blade 124 rest above the base 132. The cap 136 rests atop the opposite ends 124C, 124D to sandwich the opposite ends 124C, 124D of the blade 124 between the base 132 and cap 136. In the embodiment illustrated in FIG. 4A, the base 132 includes a plurality of pairs of slots 132B for receiving blades having different widths to cut plugs 12 of different widths. The illustrated blade 124 is sized to extend into the outer two slots 132B, though a narrower blade (having a decreased width between the opposite ends), may be received within the inner slots 132B. The outer pair of slots 132B are spaced apart from the inner pair of slots 132B.

In some embodiments, the cap 136 includes a blade engagement feature 136B (FIG. 4B) that pushes the ends 124C, 124D of the blade 124 outward (to the outside edges of the slots 132B) when tightened against the base 132. The blade engagement feature 136B may, for example, extend downward partially into the slots 132B to engage the blade 124 at the top of the slots 132B. The set screw 128 includes a handle graspable by a user and a threaded rod, the threaded rod threaded into the openings 132A, 136A to tighten the cap 136 to the base 132 and firmly secure the opposite ends 124C, 124D of the blade 124 to the sled 104. The handle of the set screw 128 is rotated to loosen and, conversely, tighten the cap 136 to the base 132 to provide for removal and replacement of the blade 124. In some embodiments, a spring is provided between the base 132 and the cap 136 and the set screw 128 tightens against the bias of the spring. As such, when the set screw 128 is loosened, the spring biases the cap 136 away from the base 132. In some embodiments, the base 132 is adjustable and/or removable to accommodate blades 124 of multiple widths.

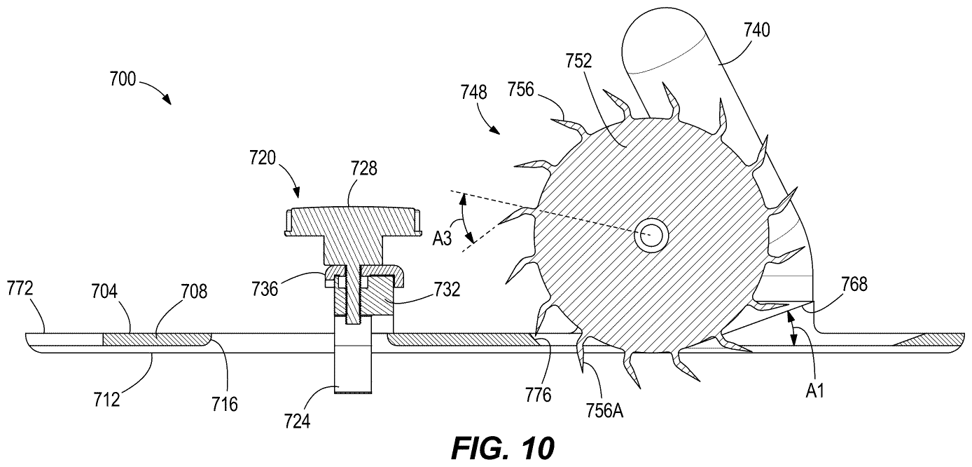

In some embodiments, such as the mineral wool cutting tool 100 shown in FIGS. 1-4B, a separator for separating the cut plug 12 from the remainder of the mineral wool 10 is omitted. In still other embodiments, such as is shown in FIGS. 6-7, the separator is incorporated with the blade 124. As shown, the blade 124 is similar to the blade 424 (FIG. 5C) with vertical sidewalls (though may have other profiles in other embodiments) but includes a separator 148 along a rear edge 124B of the blade 124. The separator 148 is an extension formed of a similar (i.e., the same) material as the reminder of the blade 124, though extends at an angle A2 (e.g., 15-40 degrees) upward and rearward of the rear edge 124B at the lower end of the blade 124. The separator 148 lifts the plug 12 upward and away from the channel 14 a sufficient distance to allow a user to more easily locate and remove the plug 12. In some embodiments, the plug 12 is lifted until it contacts the underside 112 of the sled 104, resulting in a visible separation between the plug 12 and mineral wool 10 when the cut is complete. In other embodiments, the plug 12 is lifted through an opening (similar to opening 776 shown in FIG. 10) of the sled 104 to pass through and above the top surface 108 of the sled 104.

With continued reference to FIG. 1, a guide 172 is provided at the front end of the sled 104 that corresponds to the center of the blade 124 as a visual indicator for an operator of the area to be cut by the blade 124 when the sled 104 is moved forward. As shown, the guide 172 is a slot (e.g., a triangular slot), though in other embodiments, the guide 172 may be otherwise an indicia formed or mounted on or in the sled 104, such as a line/marker formed on the sled 104, or a laser mounted to the sled. In some embodiments, as shown, each of the front end and the rear end of the sled 104 may include such guides 172. By omitting a separator, the mineral wool cutting tool 100 can be operated in either direction if the blade 124 is sharpened on both sides. In such embodiments, it may be beneficial to provide a guide 172 on both the rear and forward edges 104C, 104D of the sled 104.

In some embodiments, such as is shown in FIGS. 8-14 and 17-18, a mineral wool cutting tool 700 includes a separator 748 that is separate from the blade 724. Like elements are indicated by like reference numerals as shown in FIGS. 1-4B, incremented by 600. In addition to the sled 704 and cutting assembly, the mineral wool cutting tool 700 includes a separator 748 for displacing a plug 12 cut from the mineral wool 10 by the cutting assembly 720 from the remainder of the batt of mineral wool 10.

The separator 748 includes a wheel 752 having a plurality of teeth 756 that is mounted to a support 760 extending upward from the top surface 708 of the sled 704. The wheel 752 is rotatable about a rotational axis A1 (FIG. 8) and operates to grab and dislodge the plug 12 that is cut with the blade 724 from the remainder of the mineral wool 10. The separator 748 is beneficial because the plug 12 can be otherwise difficult to pull out by hand or even see, especially when the sidewalls of the plug 12 are vertical. The separator 748 is located rearward of the cutting assembly 720 (relative to the direction of normal travel D1) and extends through an opening 776 to below the lower surface 712 of the sled 704 a sufficient distance for the teeth 756 of the wheel 752 to grab the recently cut plug 12. In the embodiment shown, only the teeth 756 of the wheel 752 extend below the lower surface 712. As shown, the teeth 756 are angled at the tip (i.e., not extending radially from the rotational axis A1), but instead are angled towards the rotational direction of travel of the wheel 752 such that the tip of each tooth 756 is substantially perpendicular to the plug 12 when initially engaging the plug 12. As shown in FIG. 10, the angle A3 of the tips of the teeth 756 is approximately 45 degrees (e.g., 30-60 degrees, 40-50 degrees). With continued reference to FIG. 10, tooth 756A corresponds to the tooth nearest to initially engaging the mineral wool 10 and, as shown, has a distal end that is substantially perpendicular to the underside 712 of the sled 704 and the mineral wool 10 upon which the sled 704 is positioned. The wheel 752 is rotated by movement of the sled 704 and resulting engagement of the teeth with the plug 12. The teeth 756 of the wheel 752 are generally rectangular in cross-section, though in other embodiments, the teeth may have a circular cross-section and a narrower width than the width of the wheel 752.

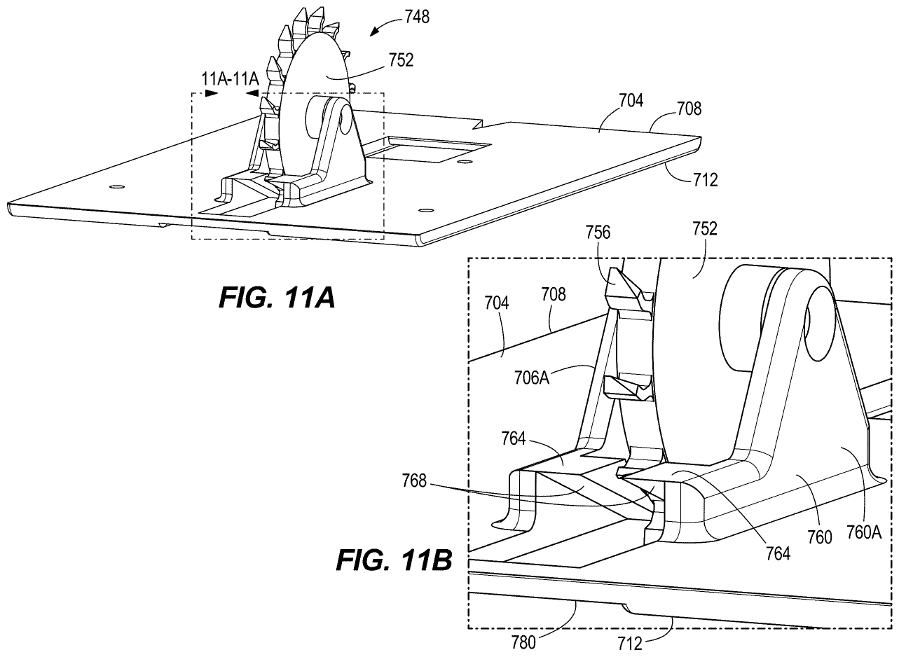

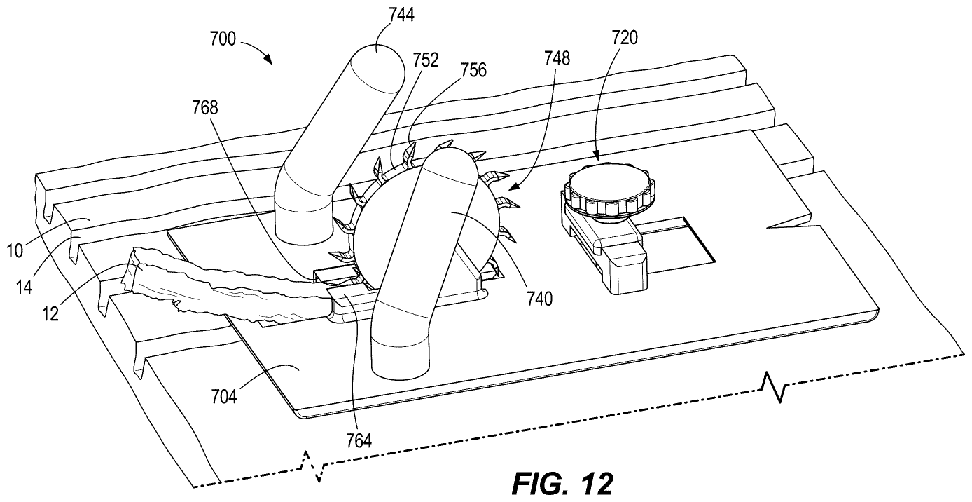

With reference to FIGS. 11A-11B, the support 760 is located on opposite sides of the wheel 752 and includes an upright 760A (FIG. 11B) on each side of the wheel 752 to support the wheel 752 for rotation about the rotational axis A1 above the sled 704. Each side of the support 760 also includes a stopping block 764 having an engagement surface 768 that separates the plug 12 from the teeth 756 of the wheel 752 to prevent the plug 12 from wrapping around the wheel 752 beyond the stopping blocks 764. In the illustrated embodiment, each of the stopping blocks 764 is integrally formed as a single piece with a respective upright 160A. As shown in FIG. 11B, the engagement surface 768 is angled upward and rearward at an angle A1 (e.g., 10-30 degrees) relative to the sled 704 such that the plug 12 is pulled upwards through the opening 776. As such, the opening 776 extends rearward of the wheel 752 a sufficient distance to allow the full height of the plug 12 (as dictated by the profile of the blade 724) to pass through the opening 776 and above the sled 704, as shown in FIG. 12. In some embodiments, the opening 776 extends fully to the rear edge 104D (FIG. 8) of the sled 704.

As shown in FIGS. 11B and 13, a channel 780 is formed within the lower surface 712 below the openings 716, 776, the cutting assembly 720, and the separator 748. The channel 780 separates the lower surface 712 into two surfaces that slide along the mineral wool 10, with the area of the channel 780 at a height above the mineral wool 10 to not compress the mineral wool 10 at the cutting assembly 720 and separator 748 as the sled 704 passes over the mineral wool 10.

In operation, the user identifies the area of the mineral wool 10 in which material is to be removed to create a channel (e.g., for aesthetic reasons). The method of creating the channel may include the following steps. An appropriate blade 124, 224, 324, 424, 524, 724, 824 is inserted into the mounting assembly by sandwiching opposite ends 124C, 124D between the base 132 and cap 136 and securing the blade 124 in position via the set screw 128. The sled 104, 704 is placed atop the mineral wool 10, with the lower surface 112, 712 of the sled 104, 704 placed flat on the surface to be cut, and moved, via pulling or pushing on the handles 140, 144, 740, 744. As the sled 104, 704 is moved along the mineral wool 10, the blade (e.g., blade 124 or blade 724) concurrently cuts a channel 14 into the material (FIGS. 12-14), by separating a plug 12 (the material located within the profile of the blade 124, 724) from the remainder of the mineral wool 10. In some embodiments, the channel cut begins at an edge of the material 10, while in other embodiments, the channel cut may begin within the center of the material 10 via a plunge cut.

In some embodiments, the plug 12 is lifted upwards and rearwards via a separator 748, 148 through an opening 776 via the separator 748 or merely providing additional separation from the remainder of the material 10 via the separator 148. In embodiments that utilize the separator 748, the toothed wheel 752 of the separator 748 grabs and, via movement of the sled 704 along the mineral wool 10, rotates the plug 12 upwards to cleanly and clearly separate the plug 12 from the channel 14. The rotating plug 12 contacts the engagement surfaces 768 of the stopping blocks 764 to dislodge the teeth 756 from the plug 12. The sled 104, 704 is continually moved along the material until a completed channel 14 is formed.

As shown in FIGS. 15-16, in some embodiments, post-cutting processes may occur to clean the channel 14. FIG. 15 illustrates cut channels 14 having imperfections such as loose fibers extending into the channel 14. A post-cutting tool in the form of a roller 600 cleans up the cut channels 14 by pressing the loose fibers into place. The roller 600 includes a central roller 604 having a profile to match that of the blade 124 (and therefore also the cut channel 14), two side rollers 608 that rest upon the uncut surface of the material (i.e., the same material that the sled 104 rests on), and a handle 612. The user holds the handle 612 and presses the roller 600 along the channel 14 with the roller 604 compressing the loose fibers and the side rollers 608 acting as a depth stop to generate the desired final channel shape. In some embodiments, the central roller 604 is removable and replaceable with rollers having other profiles to match other blades 124, such that the same handle 612 and side rollers 608 are usable, regardless of the profile of the blade 124. In some embodiments, the roller 600 is incorporated onto a trailing edge of the sled 104 to follow the blade 124 and separator 148. In operation, once the channel 14 is formed, the operator runs the roller 600 within the channel 14 until any loose fibers are compressed, resulting in a clean and smooth channel 14.

In operation, the tool 100 operates similarly to the tool 700, though the plug 12 is not separated from the remainder of the mineral wool 10. A user follows the cut by manually removing the plug 12. In other embodiments, in which the mineral wool cutting tool 100 incorporates a separator into the cutting assembly 120, as shown in FIGS. 6-7, the plug 12 is lifted until it contacts the underside 112 of the sled 104, resulting in a visible separation between the plug 12 and mineral wool 10 when the cut is complete. In still other embodiments that include an opening (similar to opening 876), the plug may be manually pulled through the opening to pass through and above the top surface 108 of the sled 104.

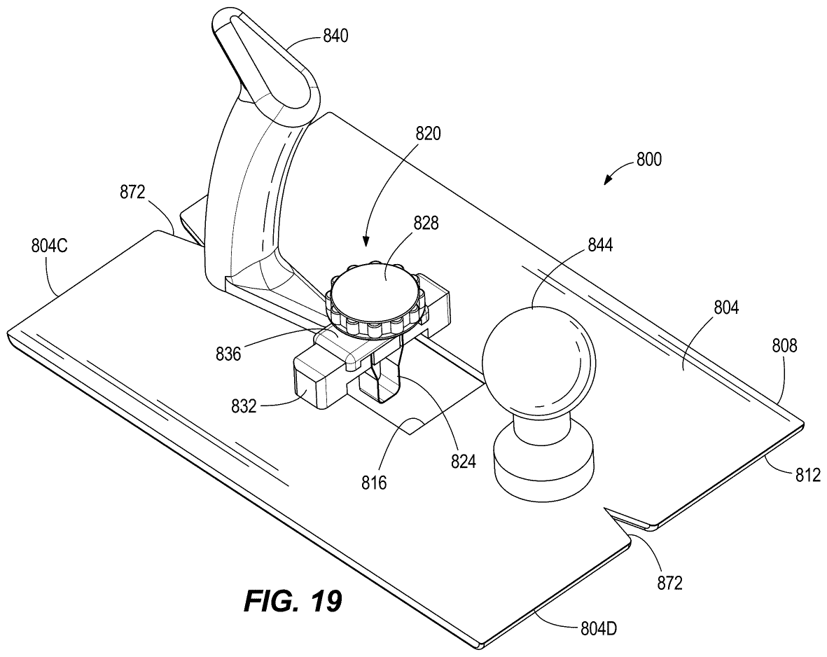

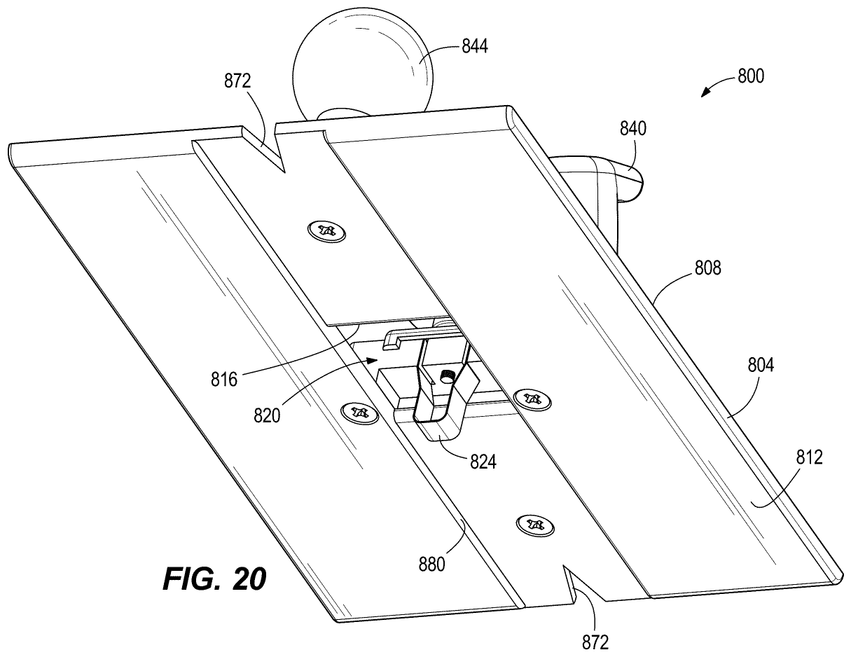

FIGS. 19-20 illustrate a still further embodiment of a mineral wool cutting tool 800 having a base 832 of the mounting assembly that is formed separately from the sled 804 and attached via threaded fasteners. Additionally, the base 832 only includes slots to support blades 824 of a particular width. The base 832 may be removable from the sled 804 and replaceable with a different base to accommodate additional blades. The Like elements are indicated by like reference numerals as shown in FIGS. 1-4B, incremented by 700.

Although the invention has been described in detail with reference to certain embodiments above, variations and modifications exist within the scope and spirit of one or more independent aspects of the invention as described.

Various features and advantages of the invention are set forth in the following claims.

What is claimed is:

1. A mineral wool cutting tool configured to create a channel within a surface of a sheet of mineral wool, the mineral wool cutting tool comprising:
a sled configured to rest on and move along the surface of the mineral wool;
a blade extending below the sled and having a closed profile and a sharpened edge configured to cut a plug from the mineral wool; and
a handle extending above the sled and graspable by a user for moving the sled along the mineral wool.

2. The mineral wool cutting tool of claim 1, further comprising a separator configured to separate the plug from a remainder of the mineral wool after being cut by the blade.

3. The mineral wool cutting tool of claim 2, wherein the separator is integrally formed with the blade as a single piece.

4. The mineral wool cutting tool of claim 2, wherein the separator is a wheel rotatably coupled to the sled and configured to grab the plug for rotation with the wheel.

5. The mineral wool cutting tool of claim 1, further comprising a mounting assembly configured to releasably secure the blade to the sled.

6. The mineral wool cutting tool of claim 5, wherein the mounting assembly includes a base coupled to the sled and a cap movably coupled to the base, and wherein the cap is configured to tighten against the base to sandwich the blade therebetween to secure the blade to the sled.

7. The mineral wool cutting tool of claim 6, further comprising a set screw configured to rotate relative to the base to tighten the cap relative to the base.

8. The mineral wool cutting tool of claim 6, wherein the base includes a pair of slots configured to simultaneously receive the blade.

9. The mineral wool cutting tool of claim 8, wherein the pair of slots is a first pair of slots and the blade is a first blade, and wherein the base further includes a second pair of slots spaced apart from the first pair of slots and configured to simultaneously receive a second blade.

10. The mineral wool cutting tool of claim 6, wherein the base is integrally formed as a single piece with the sled.

11. The mineral wool cutting tool of claim 1, wherein the blade is a first blade, wherein the mineral wool cutting tool further comprises a second blade having a different profile than the first blade, and wherein the first and second blades are interchangeable such that the mineral wool cutting tool is configured to create a first channel having the closed profile of the first blade and a second channel having the different profile of the second blade.

12. The mineral wool cutting tool of claim 1, wherein the blade is configured to cut the plug from the mineral wool when the sled is moved in a forward direction, wherein the handle is a first handle, wherein the mineral wool cutting tool further includes a second handle, and wherein the first handle is positioned rearward of the blade and the second handle is positioned forward of the blade.

13. The mineral wool cutting tool of claim 12, wherein the first handle is taller than the second handle, extending upward and rearward from the sled with a top end forming a cap that prevents a hand of the user from sliding off the first handle, and wherein the second handle is spherical for a second hand of the user to grasp.

14. The mineral wool cutting tool of claim 1, wherein the closed profile of the blade is formed by the blade at a lower end of the closed profile and by a mounting assembly at an upper end of the closed profile, and wherein the mounting assembly is positioned above the sled.

15. The mineral wool cutting tool of claim 1, further comprising a guide provided at a front end of the sled, wherein the guide is aligned with a center of the blade in a forward direction of travel of the sled.

16. A method of creating the channel within the sheet of mineral wool with the mineral wool cutting tool of claim 1, the method comprising:
moving the sled along the surface of the mineral wool;
concurrently with movement of the sled, cutting the plug from the mineral wool with the blade having the closed profile and the sharpened edge; and
separating the plug from a remainder of the mineral wool.

17. The method of claim 16, wherein moving the sled includes grasping a handle extending above the sled and pushing or pulling the sled along the mineral wool.

18. The method of claim 16, wherein separating the plug from the remainder of the mineral wool includes pulling the plug upwards through the sled.

19. A blade for use with a mineral wool cutting tool configured to create a channel within a surface of a sheet of mineral wool, the mineral wool cutting tool including a sled configured to rest on and move along the surface of the mineral wool and a mounting assembly, the blade comprising:
a metal body extending along a length between a first distal end and a second distal end, the metal body having a sharpened edge extending between the first distal end and the second distal end,
wherein the first distal end and the second distal end are configured to be grasped by the mounting assembly to mount the blade to the mineral wool cutting tool, such that a profile formed by the blade is configured to be closed by the mounting assembly.

20. The blade of claim 19, wherein the first distal end extends horizontally and the second distal end extends horizontally.

21. The blade of claim 20, wherein the first distal end is coplanar with the second distal end.

22. The blade of claim 19, wherein the length of the metal body includes at least one bend at a location spaced apart from the first distal end and the second distal end.

23. The blade of claim 19, wherein the metal body has symmetry about a central axis such that a first side of the metal body is mirrored relative to a second side of the metal body about the central axis.

24. The blade of claim 23, wherein the first distal end is on the first side of the metal body and the second distal end is on the second side of the metal body.

25. The blade of claim 19, wherein the sharpened edge is formed on a forward edge of the metal body, and wherein a depth of the blade is measured between the forward edge and a rearward edge.

26. The blade of claim 25, wherein the rearward edge is an unsharpened edge.

27. The blade of claim 19, wherein the metal body is generally U-shaped.

28. The blade of claim 19, wherein the metal body is hardened at the sharpened edge such that the sharpened edge has a greater hardness at the sharpened edge than a remainder of the metal body.

29. The blade of claim 19, wherein a forward edge of the metal body is the sharpened edge and wherein a rearward edge, opposite the forward edge is a second sharpened edge.

30. The blade of claim 19, further comprising a separator formed integrally with the metal body and extending upward and rearward from a trailing edge of the metal body to facilitate separation of a plug from a remainder of the sheet of mineral wool when creating the channel.

31. A cutting tool configured to create a channel along a surface of a material, the cutting tool comprising:
a sled configured to rest on and move along the surface of the material;
a blade extending below the sled and having a closed profile and a sharpened edge configured to cut a plug from the material; and
a separator coupled to the sled and configured to move the plug away from the material.
